(19) United States
(12) Patent Application Publication
(10) Pub. No.: US 2024/0242489 A1
(43) Pub. Date: Jul. 18, 2024

(54) IMAGE PROCESSING APPARATUS, IMAGE PROCESSING METHOD AND NON-TRANSITORY STORAGE MEDIUM

(71) Applicant: NEC Corporation, Minato-ku, Tokyo (JP)

(72) Inventors: Kazufumi KOJIMA, Tokyo (JP); Masahiro TANI, Tokyo (JP); Keisuke IKEDA, Tokyo (JP)

(73) Assignee: NEC Corporation, Minato-ku, Tokyo (JP)

(21) Appl. No.: 18/274,911

(22) PCT Filed: Jun. 17, 2021
(86) PCT No.: PCT/JP2021/023074

§ 371 Date: Jul. 28, 2023

(51) Int. Cl. G06V 10/776; G06T 7/70; G06V 10/44; G06V 10/762; G06V 10/764

(52) U.S. Cl. CPC G06V 10/776; G06T 7/70; G06V 10/44; G06V 10/762; G06V 10/764

(57) ABSTRACT

The present invention provides an image processing apparatus (10) including: an image processing unit (12) that performs, on an image, extraction processing of extracting a feature value, and estimation processing of estimating a cluster to which each pixel belongs; and a similarity degree computation unit (13) that computes a similarity degree for feature values between pixels estimated to belong to a same cluster, and thereby computes a similarity degree between two images.

### TECHNICAL FIELD

The present invention relates to an image processing apparatus, an image processing method, and a program.

### BACKGROUND ART

A technique related to the present invention is disclosed in Non-Patent Document 1. Non-Patent Document 1 discloses a technique (R2D2: repeatable and reliable detector and descriptor) of, based on an image, generating a feature value map, a repeatability map, and a reliability map, and based on them, highly accurately detecting a feature part (keypoint) of an appearance of a subject included in the image.

### RELATED DOCUMENT

### Non Patent Document

Non-Patent Document 1: Jerome Revaud, three others, “R2D2: Repeatable and Reliable Detector and Descriptor”, [online], [search on Oct. 23, 2020], Internet<URL: https://papers.nips.cc/paper/9407-r2d2-reliable-and-repeatable-detector-and-descriptor.pdf>

### DISCLOSURE OF THE INVENTION

### Technical Problem

A technique for highly accurately computing a similarity degree between two images is desired. Accuracy in computing a similarity degree between two images is improved by collating images by using keypoints that are detected by using the technique described in Non-Patent Document 1. However, further improvement of the accuracy is expected.

An object of the present invention is to provide a new technique for highly accurately computing a similarity degree between two images.

### Solution to Problem

According to the present invention, there is provided an image processing apparatus including:
an image processing unit that performs, on an image, extraction processing of extracting a feature value, and estimation processing of estimating a cluster to which each pixel belongs: and
a similarity degree computation unit that computes a similarity degree for the feature value between pixels estimated to belong to a same cluster, and thereby computes a similarity degree between two images.

In addition, according to the present invention, there is provided an image processing method executing,
by a computer:
an image processing step of performing, on an image, extraction processing of extracting a feature value, and estimation processing of estimating a cluster to which each pixel belongs: and
a similarity degree computation step of computing a similarity degree for the feature value between pixels estimated to belong to a same cluster, and thereby computing a similarity degree between two images.

In addition, according to the present invention, there is provided a program causing a computer to function as:
an image processing unit that performs, on an image, extraction processing of extracting a feature value, and estimation processing of estimating a cluster to which each pixel belongs: and
a similarity degree computation unit that computes a similarity degree for the feature value between pixels estimated to belong to a same cluster, and thereby computes a similarity degree between two images.

### Advantageous Effects of Invention

According to the present invention, a new technique for highly accurately computing a similarity degree between two images is achieved.

### BRIEF DESCRIPTION OF THE DRAWINGS

FIG. 1 It is one example of a hardware configuration diagram of an image processing apparatus according to the present example embodiment.

FIG. 2 It is one example of a function block diagram of the image processing apparatus according to the present example embodiment.

FIG. 3 It is a diagram for illustrating one example of processing of the image processing apparatus according to the present example embodiment.

FIG. 4 It is a diagram for illustrating one example of processing of the image processing apparatus according to the present example embodiment.

FIG. 5 It is a flowchart illustrating one example of a flow of processing of the image processing apparatus according to the present example embodiment.

FIG. 6 It is a flowchart illustrating one example of a flow of processing of the image processing apparatus according to the present example embodiment.

FIG. 7 It is one example of a function block diagram of the image processing apparatus according to the present example embodiment.

FIG. 8 It is a diagram schematically illustrating one example of information processed by the image processing apparatus according to the present example embodiment.

FIG. 9 It is a flowchart illustrating one example of a flow of processing of the image processing apparatus according to the present example embodiment.

FIG. 10 It is a diagram for illustrating one example of processing of the image processing apparatus according to the present example embodiment.

FIG. 11 It is a diagram for illustrating one example of processing of the image processing apparatus according to the present example embodiment.

### DESCRIPTION OF EMBODIMENTS

Hereinafter, example embodiments of the present invention will be described with reference to the drawings. Note that, in all the drawings, the similar constituent elements are denoted by the similar reference signs, and description thereof will be appropriately omitted.

### First Example Embodiment

### “Outline”

An image can include a plurality of subjects. The included subjects vary depending on an image capturing location, an image capturing timing, and the like, and for example, various targets such as a road, a plant, a building, a person, an automobile, a bus, and the sky can be subjects. When, without considering this point, keypoint matching between a first image and a second image is performed, an inconvenience can occur in that a keypoint detected from a first subject in the first image is associated with a keypoint detected from a second subject (a subject different from the first subject) in the second image. As a result, accuracy in computing a similarity degree between the two images declines.

The image processing apparatus according to the present example embodiment has a feature of reducing the inconvenience. Specifically, the image processing apparatus according to the present example embodiment performs, on a processing target image, extraction processing of extracting a keypoint, detection processing of detecting a keypoint, and estimation processing of estimating a cluster to which each pixel belongs. Then, the image processing apparatus computes a similarity degree for feature values between the keypoints estimated to belong to the same cluster, and associates the keypoints to each other, based on the computed result. Between keypoints estimated to belong to the different clusters, the image processing apparatus does not compute a similarity degree for feature values and make association. In such a manner, association between only keypoints estimated to belong to the same cluster is implemented, and association between keypoints estimated to belong to different clusters can be avoided. As a result, accuracy in computing a similarity degree between two images is improved.

### “Configuration”

Next, a configuration of the image processing apparatus will be described. First, one example of a hardware configuration of the image processing apparatus will be described. Each function unit of the image processing apparatus is implemented by an arbitrary combination of hardware and software that mainly include a central processing unit (CPU) of an arbitrary computer, a memory, a program loaded in the memory; a storage unit such as a hard disk (that can store the program stored previously from a stage of shipping the apparatus, or also the program downloaded from a storage medium such as a compact disc (CD), a server on the Internet, or the like) that stores the program, and an interface for network connection. It is understood by those skilled in the art that there are various modified examples of the implementation method and the apparatus.

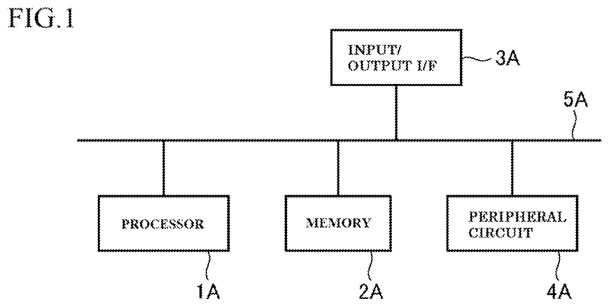

FIG. 1 is a block diagram illustrating a hardware configuration of the image processing apparatus. As illustrated in FIG. 1, the image processing apparatus includes a processor 1A, a memory 2A, an input/output interface 3A, a peripheral circuit 4A, and a bus 5A. The peripheral circuit 4A includes various modules. The image processing apparatus does not need to include the peripheral circuit 4A. Note that, the image processing apparatus may be constituted of a plurality of physically and/or logically separated apparatuses, or may be constituted of a single physically and/or logically integrated apparatus. When the image processing apparatus is constituted of a plurality of physically and/or logically separated apparatuses, each of a plurality of the apparatuses can have the above-described hardware configuration.

The bus 5A is a data transmission path for the processor 1A, the memory 2A, the peripheral circuit 4A, and the input/output interface 3A to mutually transmitting and receiving data. The processor 1A is, for example, an arithmetic processing apparatus such as a CPU or a graphics processing Unit (GPU). The memory 2A is, for example, a memory such as a random access memory (RAM) or a read only memory (ROM). The input/output interface 3A includes, for example, an interface for acquiring information from an input apparatus, an external apparatus, an external server, an external sensor, a camera, or the like, and an interface for outputting information to an output apparatus, an external apparatus, an external server, or the like. The input apparatus is, for example, a keyboard, a mouse, a microphone, a physical button, a touch panel, or the like. The output apparatus is, for example, a display, a speaker, a printer, a mailer, or the like. The processor 1A can issue a command to each module, and perform, based on arithmetic operation results thereof, arithmetic operation.

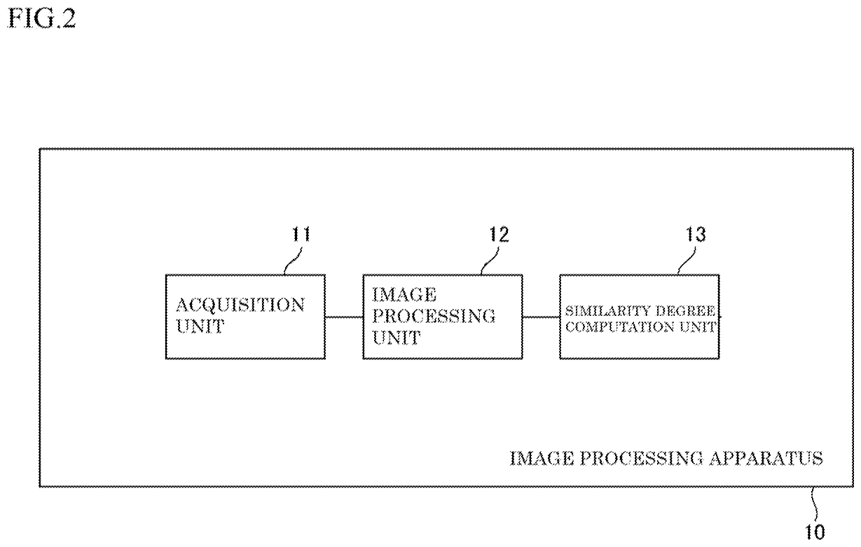

Next, a function configuration of the image processing apparatus will be described. FIG. 2 illustrates one example of a function block diagram of the image processing apparatus 10 according to the present example embodiment. As illustrated in the drawing, the image processing apparatus 10 includes an acquisition unit 11, an image processing unit 12, and a similarity degree computation unit 13.

The acquisition unit 11 acquires two images. The two images are targets for which a mutual-similarity degree is computed. For example, the acquisition unit 11 may acquire two images specified by a user input, or may acquire two images that are selected, based on a predetermined rule, from among images stored in a storage unit (database). Alternatively, the acquisition unit 11 may acquire one image specified by a user input, and acquire another image that is selected, based on a predetermined rule, from among images stored in the database.

The image processing unit 12 performs extraction processing, detection processing, and estimation processing on images acquired by the acquisition unit 11. Note that, these pieces of processing may be executed, in advance, on images stored in the database, and results of the processing may be stored, in the storage unit, in association with each of the images. In this case, the extraction processing, the detection processing, and the estimation processing do not need to be executed again on the images acquired from the database.

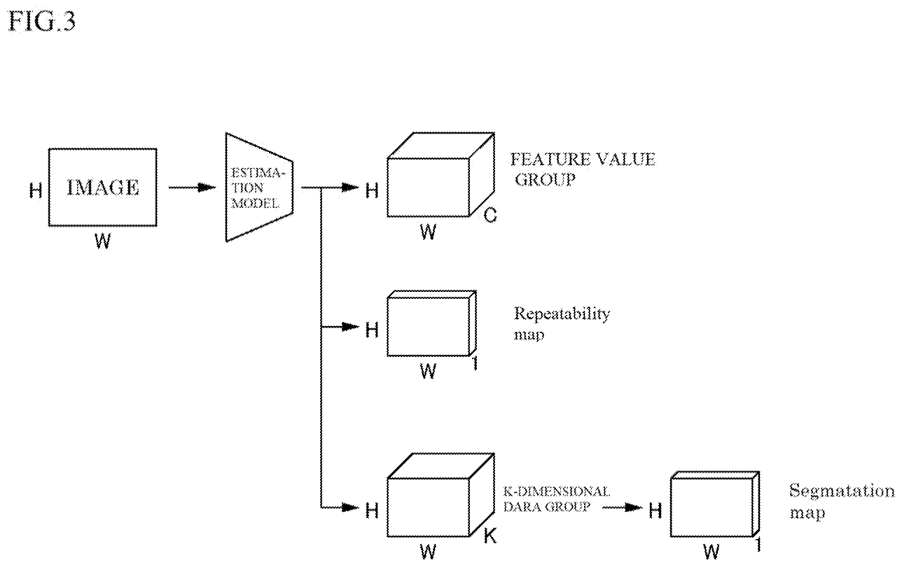

The extraction processing is processing of extracting a feature value of an image. For example, an image is input to an already-learned estimation model as illustrated in FIG. 3, and thereby, feature values of the image are extracted, and thus, data of a feature value group are generated. The data of the feature value group indicate the feature value of each pixel. In a case of the illustrated example, the feature value of each pixel is expressed by C-dimensional data. The estimation model is a convolutional neural network (CNN) for example, but is not limited to this. Generation of the data of the feature value group can be implemented by using any conventional techniques.

The detection processing is processing of detecting a keypoint from an image. Although in the present example embodiment, a keypoint is detected by using the technique described in Non-Patent Document 1, a keypoint may be detected by adopting another method. Detailed description of the technique described in Patent Document 1 is omitted herein. When the technique described in Non-Patent Document 1 is used, inputting an image to the already-learned estimation model as illustrated in FIG. 3 causes a repeatability map to be generated. The repeatability map expresses a weighting value for each pixel. The image processing unit 12 can use such a repeatability map and thereby detect a keypoint.

The estimation processing is processing of estimating a cluster to which each pixel belongs. The estimation processing divides an image into a plurality of clusters. The respective clusters are associated with respective types of subjects. For example, one cluster exists in association with a road, and another cluster exists in association with a plant. In other words, the processing of dividing an image into a plurality of clusters is processing of dividing the image into a plurality of areas for a plurality of respective subjects. As illustrated in FIG. 3, inputting an image to the already-learned estimation model causes a segmentation map to be generated. The segmentation map expresses a result of the dividing of the image into a plurality of clusters, i.e., the cluster to which each pixel belongs.

In the present example embodiment, the segmentation map is generated by using a well-known segmentation technique. Examples of the segmentation technique include semantic segmentation, instance segmentation, panoptic segmentation, and the like. In the present example embodiment, the segmentation map is generated by using an unsupervised segmentation method that uses the matter that when attention is paid to a certain pixel for example, a pixel closer thereto has stronger correlation, and a pixel more separated therefrom has weaker correlation. Based on such a segmentation map, a cluster (cluster identification information) to which each pixel belongs can be determined, but a type of a subject expressed by each pixel cannot be determined.

Note that, one example of a method of learning the above-described estimation model will be described in a fourth example embodiment.

Returning to FIG. 2, the similarity degree computation unit 13 computes a similarity degree between two images. First, the similarity degree computation unit 13 computes a similarity degree for features value between pixels estimated to belong to the same cluster, and based on the computed result, decides a combination of the pixels to be associated with each other.

Specifically, the similarity degree computation unit 13 computes a similarity degree between a first keypoint that is a keypoint (pixel) detected from the first image and a second keypoint that is a keypoint detected from the second image, and based on the computed result, decides a combination of the first keypoint and the second keypoint to be associated with each other. In this processing, the similarity degree computation unit 13 computes a similarity degree between the first keypoint and the second keypoint estimated to belong to the same cluster, and based on the computed similarity degree, decides a combination of the first keypoint and the second keypoint to be associated with each other. Note that, the similarity degree computation unit 13 does not compute a similarity degree between a first keypoint and a second keypoint estimated to belong to the different clusters. Thus, the first keypoint and the second keypoint estimated to belong to the different clusters are not associated with each other.

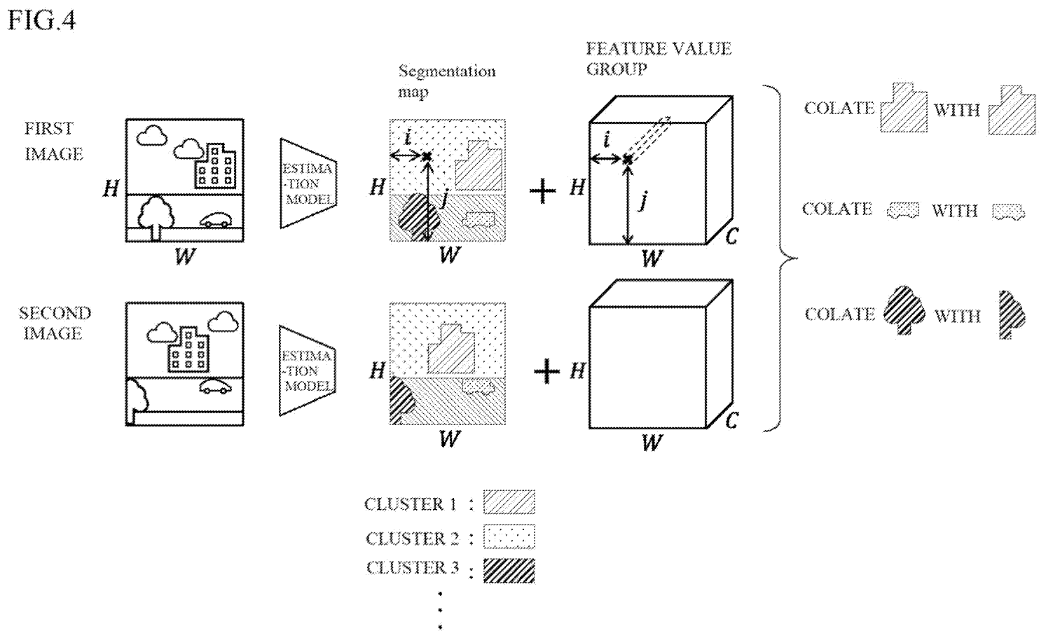

This processing will be described with reference to FIG. 4. First, it is assumed that a segmentation map and data of a feature value group as illustrated in the drawing have been generated from each of a first image and a second image. The segmentation map illustrated in the drawing expresses which cluster among clusters 1, 2, 3, . . . each pixel belongs to. The similarity degree computation unit 13 computes a similarity degree between a first keypoint that is among keypoints detected from the first image and that is estimated to belong to the cluster 1 and a second keypoint that is among keypoints detected from the second image and that is estimated to belong to the cluster 1, and based on the computed similarity degree, decides a combination of the first keypoint and the second keypoint to be associated with each other. Similarly, the similarity degree computation unit 13 computes a similarity degree between a first keypoint that is among keypoints detected from the first image and that is estimated to belong to the cluster 2 and a second keypoint that is among keypoints detected from the second image and that is estimated to belong to the cluster 2, and based on the computed similarity degree, decides a combination of the first keypoint and the second keypoint to be associated with each other. In the case of such processing, the first keypoint estimated to belong to the cluster 1 can be associated with only the second keypoint estimated to belong to the cluster 1. The first keypoint estimated to belong to the cluster 1 is not associated with the second keypoint estimated to belong to any of other clusters.

Note that, a method of computing a similarity degree between keypoints and a method of deciding keypoints to be associated with each other, based on the computed similarity degree can be implemented by adopting any conventional techniques.

After the similarity degree computation unit 13 decides a combination (a combination of keypoints) of pixels to be associated with each other, the similarity degree computation unit 13 computes a similarity degree between the two images, based on the result of the association. A method of computing a similarity degree between the two images, based on the result of the association can be implemented by adopting any conventional techniques.

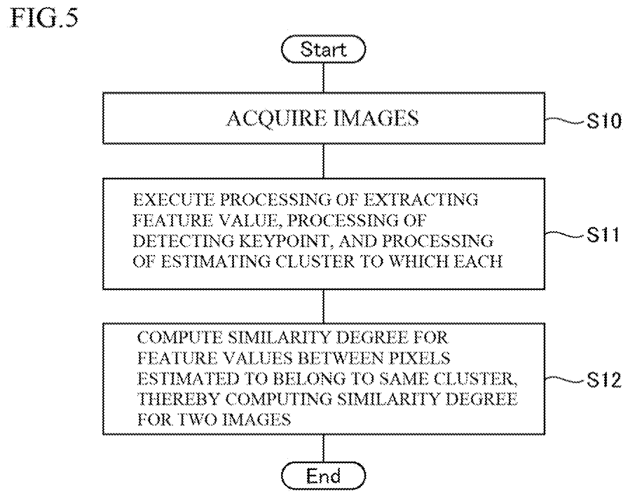

Next, one example of a flow of processing of the image processing apparatus 10 will be described with reference to a flowchart in FIG. 5.

First, the image processing apparatus 10 acquires two images for which a mutual-similarity degree is computed (S10).

Next, the image processing apparatus 10 executes, on each of the images, the extraction processing of extracting a feature value, the detection processing of detecting a keypoint, and the estimation processing of estimating a cluster to which each pixel belongs (S11). Note that, when the image acquired at S10 have been subjected, in advance, to the extraction processing, the detection processing, and the estimation processing, and the results are stored in a database, the image processing apparatus 10 may acquire the results from the database, and does not need to execute, on the image, the extraction processing, the detection processing, and the estimation processing, again.

Next, the image processing apparatus 10 computes a similarity degree for feature values between pixels estimated to belong to the same cluster. Then, the image processing apparatus decides, based on the computed result, a combination of keypoints to be associated with each other, and computes a similarity degree between the two images, based on the result of the association (S12).

### Advantageous Effect

As described above, the image processing apparatus 10 according to the present example embodiment performs, on a processing target image, the extraction processing of extracting a feature value, the detection processing of detecting a keypoint, and the estimation processing of estimating a cluster to which each pixel belongs. Then, the image processing apparatus 10 computes a similarity degree for the feature values between the keypoints estimated to belong to the same cluster, and associates the keypoints to each other, based on the computed result. Between the keypoints estimated to belong to the different clusters, the image processing apparatus 10 does not compute a similarity degree for the feature values and make association. In such a manner, association between only keypoints estimated to belong to the same cluster is implemented, and association between keypoints estimated to belong to different clusters can be avoided. As a result, accuracy in computing a similarity degree between two images is improved.

### Second Example Embodiment

In the present example embodiment, a plurality of clusters are classified into a reference cluster and a non-reference cluster, based on a user input. Then, the image processing apparatus 10 uses keypoints estimated to belong to the reference cluster, without using keypoints estimated to belong to the non-reference cluster, and thereby computes a similarity degree for feature values between keypoints estimated to belong to the same cluster, and based on the result, associates the keypoints to each other, and thereby computes a similarity degree between two images, which are described above in the first example embodiment.

One example of a function block diagram of the image processing apparatus 10 according to the present example embodiment is illustrated in FIG. 2 as in the first example embodiment.

The similarity degree computation unit 13 computes a similarity degree between a first keypoint that is a keypoint (pixel) detected from a first image and a second keypoint that is a keypoint detected from a second image, and based on the computed result, decides a combination of the first keypoint and the second keypoint to be associated with each other. In this processing, the similarity degree computation unit 13 uses only the keypoints estimated to belong to the reference cluster, and does not use the keypoints estimated to belong to the non-reference cluster.

In other words, the similarity degree computation unit 13 uses only the keypoints estimated to belong to the reference cluster, thereby computes a similarity degree between the first keypoint and the second keypoint estimated to belong to the same cluster, and based on the computed similarity degree, decides a combination of the first keypoint and the second keypoint to be associated with each other. Note that, the similarity degree computation unit 13 does not use, in this processing, keypoints estimated to belong to the non-reference clusters. Thus, the keypoints estimated to belong to the non-reference clusters are not associated with any of the keypoints. Similarly to the first example embodiment, the similarity degree computation unit 13 does not compute a similarity degree between the first keypoint and the second keypoint estimated to belong to the different clusters. Thus, the first keypoint and the second keypoint estimated to belong to the different clusters are not associated with each other.

Herein, one example of a method of classifying clusters into the reference cluster and the non-reference cluster will be described. A user makes an input that decides which of the reference cluster and the non-reference cluster each of a plurality of clusters (clusters 1, 2, 3, . . . ) is classified into. The user may make an input for the classification for each combination of images for which a similarity degree is computed. Alternatively, contents input by the user for the classification may be stored in the image processing apparatus 10, and the classification contents may be applied to a combination of a plurality of images. Based on the user input, the similarity degree computation unit 13 determines which of the reference cluster and the non-reference cluster each of a plurality of clusters is classified into.

Herein, one example of an interface screen for receiving the input of the user will be described. For example, the image processing apparatus 10 outputs an interface screen that displays a segmentation map (a segmentation map generated from the first image or a segmentation map generated from the second image) such as that illustrated in FIG. 4. The segmentation map illustrated in FIG. 4 uses a method such as contour lines or color-coding and thus expresses boundaries among a plurality of clusters, and thereby displays a plurality of the clusters in such a way as to be identifiable from one another. The interface screen is configured in such a way as to receive, for each of a plurality of the clusters expressed by the segmentation map, a user input specifying which of the reference cluster and the non-reference cluster each of the clusters is classified into.

For example, the user can estimate a type of a subject expressed by each cluster, based on a shape (a shape formed by pixels belonging to each cluster) of each of a plurality of the clusters expressed by the segmentation map. In another example, the image processing apparatus 10 may display, on the interface screen, together with the segmentation map illustrated in FIG. 4, an image that is an original of the segmentation map. Then, the user may view and compare the segmentation map and the image that is the original of the segmentation map, and thereby identify a type of a subject expressed by each of a plurality of the clusters expressed by the segmentation map.

Note that, which cluster is classified into the reference cluster can be freely decided by considering a factor such as a use place of the image processing device 10. For example, as described in a third example embodiment, when a position (image-captured position) expressed by the image is determined by using a computed result of a similarity degree between images, it is preferable that subjects such as a building and a road whose existing positions are fixed are classified into the reference cluster, and subjects such as a person and an automobile whose existing positions change are classified into the non-reference cluster.

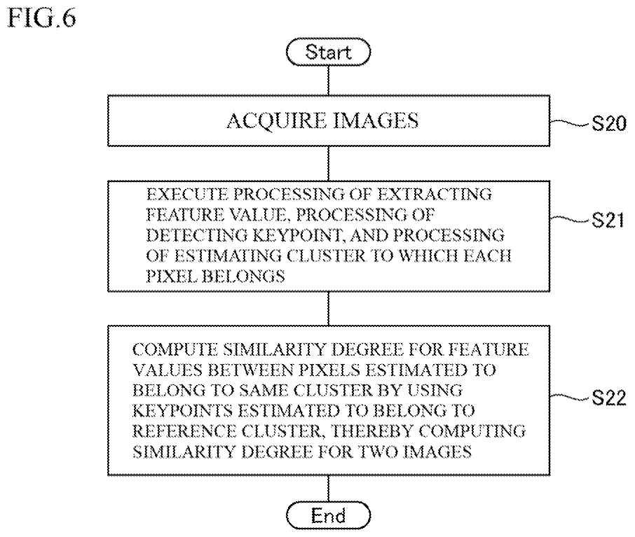

Next, one example of a flow of processing of the image processing apparatus 10 will be described with reference to a flowchart in FIG. 6.

First, the image processing apparatus 10 acquires two images for which a mutual-similarity degree is computed (S20).

Next, the image processing apparatus 10 executes, on each of the images, the extraction processing of extracting a feature value, the detection processing of detecting a keypoint, and the estimation processing of estimating a cluster to which each pixel belongs (S21). Note that, when the image acquired at S20 have been subjected, in advance, to the extraction processing, the detection processing, and the estimation processing, and the results are stored in the database, the image processing apparatus 10 may acquire the results from the database, and does not need to execute, on the image, the extraction processing, the detection processing, and the estimation processing, again.

Next, the image processing apparatus 10 uses the keypoints estimated to belong to the reference cluster without using the keypoints estimated to belong to the non-reference cluster and thus computes a similarity degree for the feature values between the keypoints estimated to belong to the same cluster, and thereby computes a similarity degree between the two images (S22).

Other configurations of the image processing apparatus 10 according to the present example embodiment are similar to those in the first example embodiment.

According to the image processing apparatus 10 of the present example embodiment, the advantageous effect similar to that of the image processing apparatus 10 of the first example embodiment is achieved. In addition, according to the image processing apparatus 10 of the present example embodiment, a similarity degree between images can be computed by using only appropriate clusters, and thereby, accuracy in computing a similarity degree is improved.

### Third Example Embodiment

The image processing apparatus 10 according to the present example embodiment has a function of computing a similarity degree between a processing target image and each of a plurality of reference images with which position information is associated, and outputting, based on the computed result, position information related to the processing target image. Hereinafter, the details will be described.

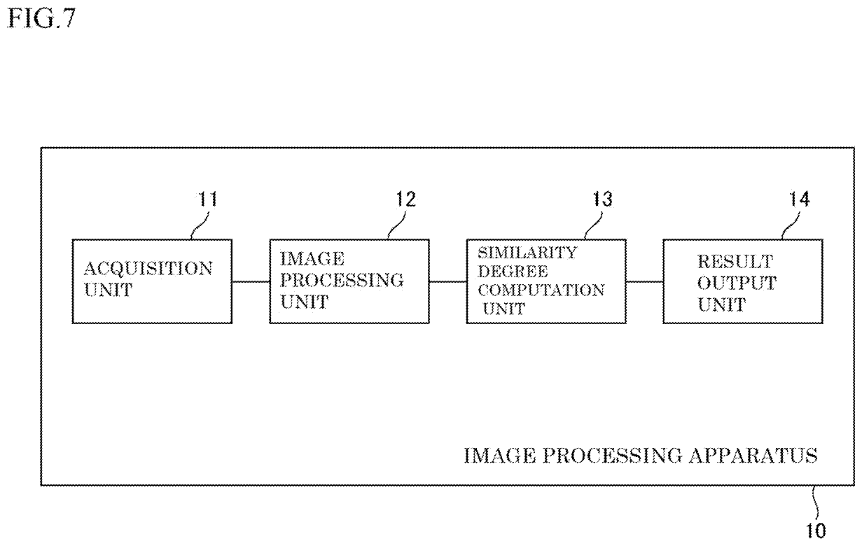

FIG. 7 illustrates one example of a function block diagram of the image processing apparatus 10 according to the present example embodiment. As illustrated in the drawing, the image processing apparatus 10 includes the acquisition unit 11, the image processing unit 12, the similarity degree computation unit 13, and a result output unit 14.

The acquisition unit 11 acquires a processing target image. The acquisition unit 11 acquires a processing target image that is, for example, specified, selected, or decided by an input made by a user. An image for which position information of an image-captured position (a position of a camera when the image was captured) is required is acquired as the processing target image. For example, an image to which a geotag is not attached and for which an image-captured position is unknown is acquired as the processing target image.

The image processing unit 12 performs, on a processing target image, the extraction processing of extracting a feature value, the detection processing of detecting a keypoint, and the estimation processing of estimating a cluster to which each pixel belongs. Details of each piece of processing are similar to those in the first and second example embodiments.

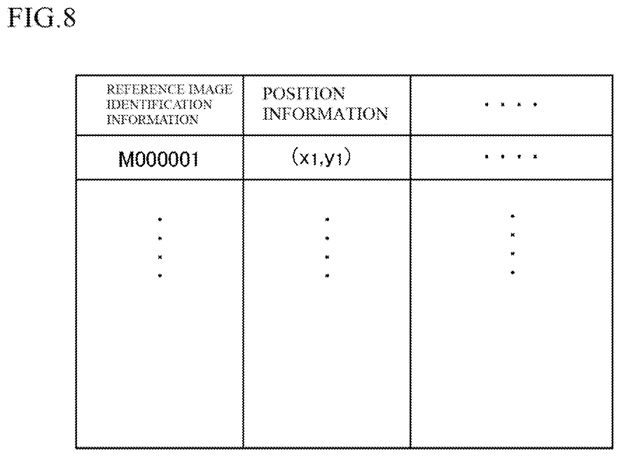

The similarity degree computation unit 13 computes a similarity degree between the processing target image and each of a plurality of reference images stored in a database. The image processing apparatus 10 may include the database, or an external apparatus configured in such a way as to communicate with the image processing apparatus 10 may include the database. FIG. 8 schematically illustrates one example of information stored in the database. In the example illustrated in the drawing, position information is registered in association with each of a plurality of reference images. The position information expresses a position expressed by each reference image. The position information may indicate a relatively narrow area by using a latitude and a longitude, an address, or the like, or may indicate a relatively wide area by using a country name, a prefecture name, a name of a city, a district, a town, or a village, or the like.

Details of the processing of computing a similarity degree are similar to those in the first and second example embodiments. Note that, when the second example embodiment is adopted, it is preferable that subjects such as a building and a road whose existing positions are fixed are classified into the reference cluster, and subjects such as a person and an automobile whose existing positions change are classified into the non-reference cluster.

Position information associated with the reference image whose similarity degree to the processing target image is equal to or larger than a threshold value is output, by the result output unit 14, as position information related to the processing target image, i.e., position information expressed by the processing target image.

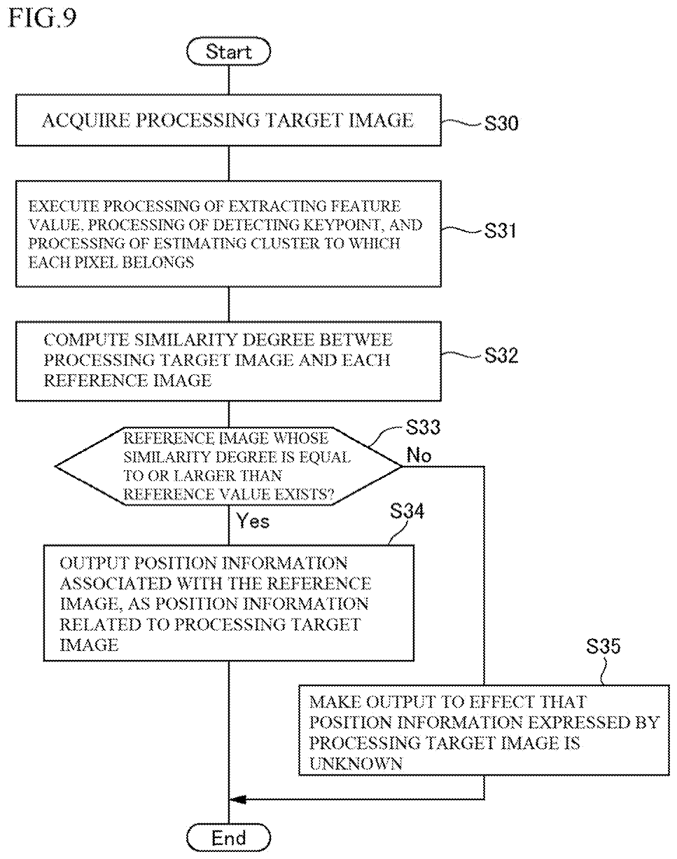

Next, one example of a flow of processing of the image processing apparatus 10 will be described with reference to the flowchart of FIG. 9.

First, the image processing apparatus 10 acquires a processing target image (S30).

Next, the image processing apparatus 10 executes, on the processing target image, the extraction processing of extracting a feature value, the detection processing of detecting a keypoint, and the estimation processing of estimating a cluster to which each pixel belongs (S31).

Next, the image processing apparatus 10 computes a similarity degree between the processing target image and each of a plurality of the reference images stored in the database (S32).

Then, when the reference image whose similarity degree to the processing target image is equal to or larger than a reference value exists (yes at S33), the image processing apparatus 10 outputs the position information associated with the reference image, as position information related to the processing target image, i.e., position information expressed by the processing target image (S34).

On the other hand, when no reference image whose similarity degree to the processing target image is equal to or larger than the reference value exists (no at S33), the image processing apparatus 10 makes an output to the effect that position information expressed by the processing target image is unknown (S35).

Other configurations of the image processing apparatus 10 according to the present example embodiment are similar to those in the first and second example embodiments.

According to the image processing apparatus 10 of the present example embodiment, the advantageous effects similar to those of the image processing apparatuses 10 according to the first and second example embodiments are achieved. In addition, according to the image processing apparatus 10 of the present example embodiment, a similarity degree between images can be determined highly accurately, and thereby, using the result enables a position expressed by the image to be determined highly accurately.

### Fourth Example Embodiment

In the present example embodiment, the estimation model used in the extraction processing of extracting a feature value, the detection processing of detecting a keypoint, and the estimation processing of estimating a cluster to which each pixel belongs is learned by a characteristic method.

First, a pair of images including the same subject are used as training data. A pair of the images may be a pair of different images generated by image-capturing of the same subject at different timings. In this case, a pair of the different images may be different from each other or the same as each other, in an image-capturing angle, a distance to the subject, a lighting condition, and/or the like. In another example, image processing such as color tone changing is performed on a certain image, and thereby, a pair of images (a pair of the image before the editing and the image after the editing) including the same subject may be made.

A learning apparatus that learns the estimation model inputs each of a pair of images A and B to the estimation model, and thereby executes, on a pair of images A and B, the extraction processing, the detection processing, and the estimation processing. As a result, for each of the images A and B, the outcomes (data of a feature value group, a repeatability map, a K-dimensional data group, a segmentation map, and the like) such as those illustrated in FIG. 3 for example are acquired. Then, the learning apparatus optimizes various parameters of the estimation model, based on at least one of these outcomes and on a characteristic loss function. In other words, the learning apparatus optimizes the various parameters of the estimation model in such a way as to minimize the loss function.

The loss function L is defined as in the following equation (1). The loss function L is generated based on a loss function L_{seg} and a loss function Lᵣₑₚ. In the equation (1), the loss function L is the sum of the loss function L_{seg} and the loss function Lᵣₑₚ.

### [Math. 1]

$$L = {L}_{s e g} + {L}_{r e p} \qquad Equation ( 1 )$$

The loss function Lᵣₑₚ is defined as in the following equation (2). The loss function Lᵣₑₚ is a loss function concerning repeatability of a feature value. The details are as disclosed in Non-Patent Document 1, and thus, description thereof is omitted herein.

### [Math. 2]

$${L}_{rep} ( I , {I}^{′} , U ) + {L}_{cosim} ( I , {I}^{′} , U ) + \frac{1}{2} ( {L}_{peaky} ( I ) + {L}_{peaky} ( {I}^{′} ) ) \qquad Equation ( 2 )$$

The loss function L_{seg} is a loss function concerning inter-pixel correlation. The loss function L_{seg} is a statistical value (an average value or the like) of a value that is computed for each pixel, based on a function L_{seg.u}. The function L_{seg.u} is defined as in the following equation (3).

### [Math. 3]

$${L}_{seg , u} = 1 - \frac{1}{\vert T \vert} {\sum }_{t ∈ T} I ( {F}_{u} , {F}_{g ( u ) + t}^{′} ) \qquad Equation ( 3 )$$

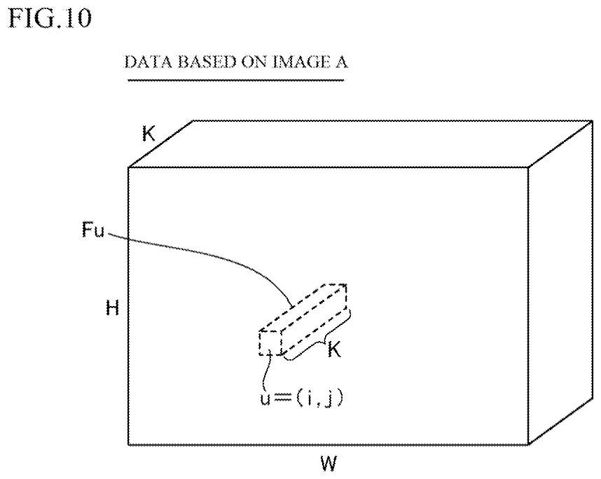

The function Fu is K-dimensional data of the pixel u (=(i, j)) of the image A, as illustrated in FIG. 10.

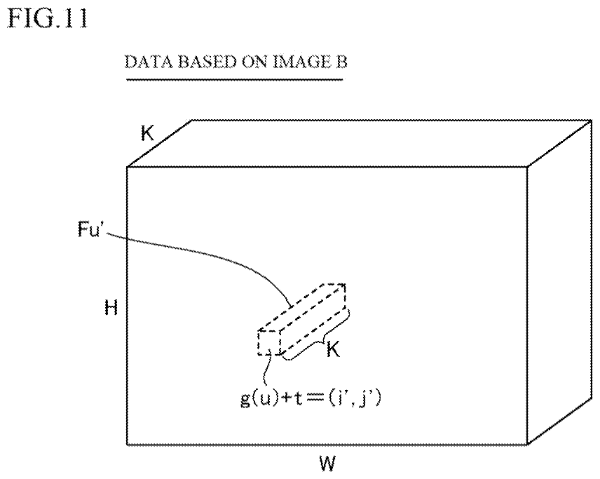

The function F′_{g(u)+t} is K-dimensional data of a pixel {g(u)+t} in the image B, as illustrated in FIG. 11. The pixel {g(u)+t} in the image B is a pixel displaced from a pixel g(u) in the image B by a displacement amount t. The pixel g(u) in the image B is a pixel associated with a pixel u in the image A. The pixels associated with each other indicate the same part in the same subject.

The function T is a set of predefined displacement amounts t.

The function I is defined as in the following equation (4). The function H is an entropy function.

### [Math. 4]

$$I = H ( {F}_{u} ) - H ( {F}_{u} \vert {F}_{g ( u ) + t}^{′} ) \qquad Equation ( 4 )$$

The image processing unit 12 of the image processing apparatus 10 according to the present example embodiment executes, based on the estimation model learned by the characteristic method such as that described above, the extraction processing of extracting a feature value, the detection processing of detecting a keypoint, and the estimation processing of estimating a cluster to which each pixel belongs. Other configurations of the image processing apparatus 10 according to the present example embodiment are similar to those in the first to third example embodiments.

As described above, according to the image processing apparatus 10 of the present example embodiment, the advantageous effects similar to those in the first to third example embodiments are achieved. In addition, according to the image processing apparatus 10 of the present example embodiment, the extraction processing of extracting a feature value, the detection processing of detecting a keypoint, and the estimation processing of estimating a cluster to which each pixel belongs are executed based on the estimation model learned by the characteristic method. Thus, accuracy of these pieces of processing is improved.

Note that, in the present description, “acquisition” includes at least one of: “to take out, by the self-apparatus, data stored in another apparatus or storage medium (active acquisition)” such as making a request or an inquiry to another apparatus and thereby receiving data or accessing another apparatus or storage medium and thereby reading out data, based on a user input or based on a command of a program, or “to input, to the self-apparatus, data output from another apparatus (passive acquisition)” such as receiving data delivered (or transmitted, or for which push notification is made, for example) or selecting and acquiring data from received data or information, based on a user input or based on a command of a program: and “to generate new data by editing data (converting into texts, rearranging data, extracting a part of data, changing a file format, or the like) for example and thereby acquire the new data”.

A part or all of the above-described example embodiments can be described as in the following supplementary notes, but there is no limitation to the following.

1. An image processing apparatus including:
an image processing unit that performs, on an image, extraction processing of extracting a feature value, and estimation processing of estimating a cluster to which each pixel belongs: and
a similarity degree computation unit that computes a similarity degree for the feature value between pixels estimated to belong to a same cluster, and thereby computes a similarity degree between two images.

2. The image processing apparatus according to the supplementary note 1, wherein
a plurality of the clusters are classified into a reference cluster and a non-reference cluster, and
the similarity degree computation unit uses a pixel estimated to belong to the reference cluster without using a pixel estimated to belong to the non-reference cluster, and thereby computes a similarity degree for the feature value.

3. The image processing apparatus according to the supplementary note 2, wherein
a plurality of the clusters are classified into the reference cluster and the non-reference cluster, based on a user input.

4. The image processing apparatus according to any one of the supplementary notes 1 to 3, wherein
the similarity degree computation unit decides a pixel being a keypoint, computes a similarity degree for the feature value between the pixels decided as the keypoints, and thereby computes a similarity degree between two images.

5. The image processing apparatus according to any one of the supplementary notes 1 to 4, wherein
the similarity degree computation unit computes a similarity degree between a processing target image and each of a plurality of reference images associated with position information,
the image processing apparatus further including
a result output unit that outputs, as the position information related to the processing target image, the position information associated with the reference image for which the similarity degree to the processing target image is equal to or larger than a threshold value.

6. The image processing apparatus according to any one of the supplementary notes 1 to 5, wherein
the image processing unit performs the extraction processing and the estimation processing, based on an estimation model learned based on a loss function being generated based on a loss function concerning inter-pixel correlation and a loss function concerning repeatability of a feature value.

7. An image processing method executing,
by a computer:
an image processing step of performing, on an image, extraction processing of extracting a feature value, and estimation processing of estimating a cluster to which each pixel belongs; and
a similarity degree computation step of computing a similarity degree for the feature value between pixels estimated to belong to a same cluster, and thereby computing a similarity degree between two images.

8. A program causing a computer to function as:
an image processing unit that performs, on an image, extraction processing of extracting a feature value, and estimation processing of estimating a cluster to which each pixel belongs; and
a similarity degree computation unit that computes a similarity degree for the feature value between pixels estimated to belong to a same cluster, and thereby computes a similarity degree between two images.

### REFERENCE SIGNS LIST

10 Image processing apparatus
11 Acquisition unit
12 Image processing unit
13 Similarity degree computation unit
14 Result output unit
1A Processor
2A Memory
3A Input/output I/F
4A Peripheral circuit
5A Bus

What is claimed is:

1. An image processing apparatus comprising:
at least one memory configured to store one or more instructions; and
at least one processor configured to execute the one or more instructions to:
perform, on an image, extraction processing of extracting a feature value, and estimation processing of estimating a cluster to which each pixel belongs; and
compute a similarity degree for the feature value between pixels estimated to belong to a same cluster, and thereby compute a similarity degree between two images.

2. The image processing apparatus according to claim 1, wherein
a plurality of the clusters are classified into a reference cluster and a non-reference cluster, and
the processor is further configured to execute the one or more instructions to use a pixel estimated to belong to the reference cluster without using a pixel estimated to belong to the non-reference cluster, and thereby compute a similarity degree for the feature value.

3. The image processing apparatus according to claim 2, wherein
a plurality of the clusters are classified into the reference cluster and the non-reference cluster, based on a user input.

4. The image processing apparatus according to claim 1, wherein
the processor is further configured to execute the one or more instructions to decide a pixel being a keypoint, computes a similarity degree for the feature value between the pixels decided as the keypoints, and thereby compute a similarity degree between two images.

5. The image processing apparatus according to claim 1, wherein the processor is further configured to execute the one or more instructions to
compute a similarity degree between a processing target image and each of a plurality of reference images associated with position information, and
output, as the position information related to the processing target image, the position information associated with the reference image for which the similarity degree to the processing target image is equal to or larger than a threshold value.

6. The image processing apparatus according to claim 1, wherein
the processor is further configured to execute the one or more instructions to perform the extraction processing and the estimation processing, based on an estimation model learned based on a loss function being generated based on a loss function concerning inter-pixel correlation and a loss function concerning repeatability of a feature value.

7. An image processing method executing,
by a computer:
performing, on an image, extraction processing of extracting a feature value, and estimation processing of estimating a cluster to which each pixel belongs; and
computing a similarity degree for the feature value between pixels estimated to belong to a same cluster, and thereby computing a similarity degree between two images.

8. A non-transitory storage medium storing a program causing a computer to:
perform, on an image, extraction processing of extracting a feature value, and estimation processing of estimating a cluster to which each pixel belongs; and
compute a similarity degree for the feature value between pixels estimated to belong to a same cluster, and thereby compute a similarity degree between two images.
